(19) United States
(12) Patent Application Publication
(10) Pub. No.: US 2012/0000019 A1
(43) Pub. Date: Jan. 5, 2012

(54) PLIERS

(76) Inventors: Michael S. Steele, Waukesha, WI (US); Wade Burch, Wauwatosa, WI (US); Timothy Albrecht, Menomonee Falls, WI (US); Michael W. Phillips, Milwaukee, WI (US); Brandon Miller, Milwaukee, WI (US)

(21) Appl. No.: 13/099,833

(22) Filed: May 3, 2011

Related U.S. Application Data
(60) Provisional application No. 61/330,784, filed on May 3, 2010.

(51) Int. Cl. B25B 7/22; B23P 15/00; B25F 1/00

(52) U.S. Cl. 7/107; 81/427.5; 29/527.1

(57) ABSTRACT

A pliers that includes a first member and a second member pivotally coupled to the first member. The pliers includes a head, a handle, a first end defining a nose of the head portion, and a second end, opposite the first end, defined by the handle of the pliers. Ridges are disposed on the first and the second members adjacent the nose and together define a grip of the pliers. Sharp edges of the first and second members are adjacent the ridges and between the ridges and the second end of the pliers and together define a cutter of the pliers. An aperture extends through the first member adjacent a pivot and between the pivot and the second end of the pliers, and the threaded aperture and the second member define a threaded fastener cutter of the pliers.

### CROSS-REFERENCE TO RELATED APPLICATIONS

This application claims priority to U.S. Provisional Patent Application No. 61/330,784, filed May 3, 2010, the entire contents of which are hereby incorporated by reference herein.

### BACKGROUND

The present invention relates to pliers.

A pliers often includes two members that are pivotally connected at a pivot point. A rear end portion of the pliers typically forms a handle of the pliers and a front end portion forms a head of the pliers. The handle is used to open or close jaws formed at the head that pivot about the pivot point, and the handles can be rotated to rotate the head. Therefore, the jaws can be used to grip a fastener, wire, or any suitable material, and the pliers is rotated via the handle to rotate the fastener, wire, or material.

Traditionally, pliers have had their handles dipped in a bath of rubber. With this traditional process, the rubber can easily rip, tear, crack or slide off of the frame. In other traditional processes, the grips are premolded separate from the tool and then glued and pressed onto the frame. With this traditional process, the glue can breakdown, especially if the tool becomes hot, and the grips pull off of the tool.

### SUMMARY

In one embodiment, the invention provides a pliers including a first member having a head portion and a handle portion and a second member pivotally coupled to the first member. The second member includes a head portion and a handle portion, and the head portions of the first and the second members define a head of the pliers and the handle portions of the first and the second members define a handle of the pliers. The pliers further includes a first end that defines a nose of the head portion, a second end, opposite the first end, defined by the handle of the pliers, and a first plurality of ridges disposed on the first member adjacent the nose. A second plurality of ridges is disposed on the second member adjacent the nose, and the first and the second plurality of ridges together define a grip of the pliers. A first sharp edge is disposed on the first member adjacent the first plurality of ridges and between the first plurality of ridges and the second end of the pliers. A second sharp edge is disposed on the second member adjacent the second plurality of ridges and between the second plurality of ridges and the second end of the pliers. Together the first and second sharp edges define a cutter of the pliers. A pivot pivotally couples the first member and the second member adjacent the cutter and between the cutter and the second end of the pliers, and an aperture extends through the first member adjacent the pivot and between the pivot and the second end of the pliers. The aperture and the second member define a fastener cutter of the pliers.

In another embodiment, the invention provides a pliers including a first member having a head portion and a handle portion and a second member pivotally coupled to the first member. The second member includes a head portion and a handle portion, and the head portions of the first and the second members define a head of the pliers and the handle portions of the first and the second members define a handle of the pliers. A first resilient grip member is located on the handle portion of the first member, and the first resilient grip member abuts the head portion of the first member such that an outer surface of the first resilient grip member is flush with the head portion of the first member to define a smooth transition between the first resilient grip member and the head portion of the first member. A second resilient grip member is located on the handle portion of the second member, the second resilient grip member abuts the head portion of the second member such that an outer surface of the second resilient grip member is flush with the head portion of the second member to define a smooth transition between the first resilient grip member and the head portion of the second member.

In another embodiment, the invention provides a method of manufacturing a pliers including providing a frame that defines a head and a handle of the pliers, molding a resilient grip member directly onto the handle of the pliers, and where molding the resilient grip member onto the handle includes extending a portion of the resilient grip member into a recess of the handle to fixably couple the resilient grip member to the handle.

Other aspects of the invention will become apparent by consideration of the detailed description and accompanying drawings.

### BRIEF DESCRIPTION OF THE DRAWINGS

FIG. 1 is a front perspective view of a pliers according to one embodiment of the invention.

FIG. 2 is a rear perspective view of the pliers of FIG. 1.

FIG. 3 is a side view of the pliers of FIG. 1.

FIG. 4 is a side view of the pliers of FIG. 1 with grip members removed.

FIG. 5 is an exploded view of a portion of the pliers of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

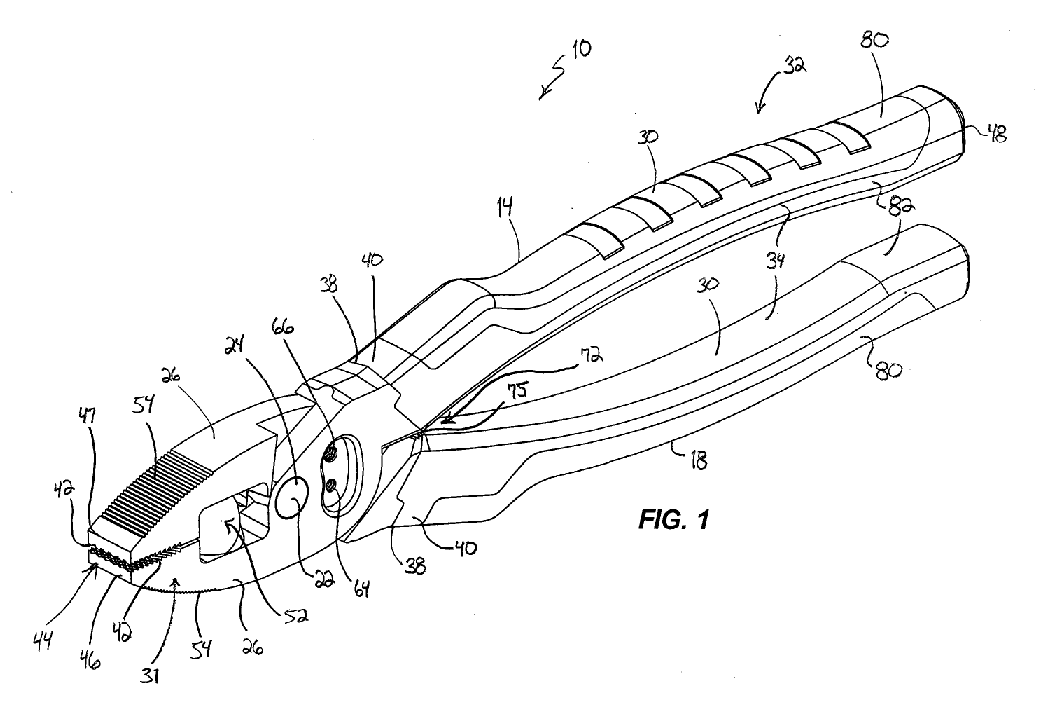

FIG. 1 illustrates a pliers 10, which in the illustrated embodiment is referred to as a lineman's pliers. The pliers 10 includes a first member 14 and a second member 18 that is pivotally connected to the first member 14 such that the members 14, 18 pivot with respect to each other about a pivot point 22. A pin 24 is used to pivotally couple the members 14, 18 and defines the pivot point 22. The members 14, 18 both include a head portion 26 and a handle portion 30. Together the head portions 26 define a head 31 of the pliers 10 and together the handle portions 30 define a handle 32 of the pliers 10. In one embodiment, the members 14, 18 are formed from corrosion resistant metal and the head portions 26 are cryogenically treated to increase the gripping life of the pliers 10. A chemically bonded coating may be placed over all of the cast and machined surfaces to increase the corrosion resistance of the tool and to provide an attractive gray or black finish to the tool. Hand tools are often exposed to wet environments and experience corrosion and the chemically bonded coating increases the resistance to such corrosion.

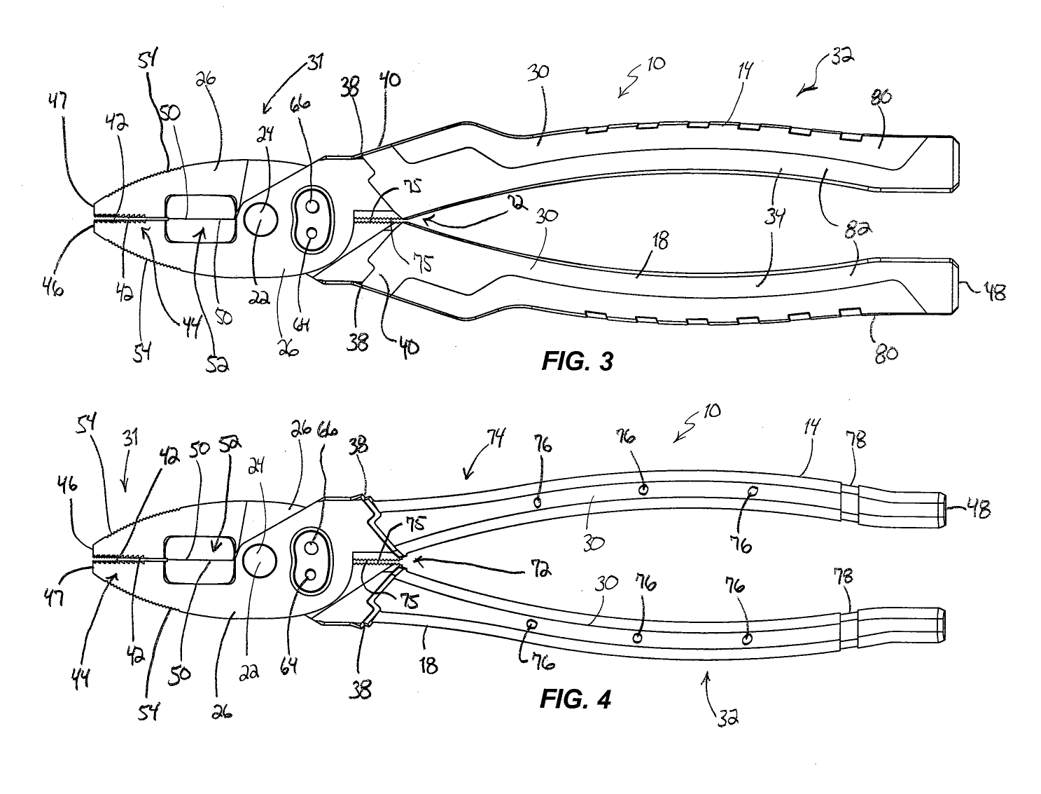

The handle portions 30 are both covered with a rubber (or other suitable grip material) over mold 34 to form a resilient grip member of the handle portions 30 while the metal of the head portions 26 remains exposed. The rubber over molds 34 provide extra durability, increase user comfort, and reduce slippage of the user's hand on the pliers 10. The over molds 34 both abut the adjacent head portion 26 at a transition area 38. The rubber over molds 34, head portions 26, and handle portions 30 are formed such that there is a smooth transition between the over mold 34 and the adjacent head portion 26 at the transition area 38. Alternatively stated, an outer surface 40 of the over mold 34 is flush with the adjacent head portion 26. This smooth transition between the exposed metal of the head portion 26 and the rubber over mold 34 helps to reduce the likelihood of the over molds 34 getting caught on a tool pouch, tool bucket, etc. and ripping the over molds 34 or grip of the pliers 10. The method of over molding the pliers 10 will be discussed in more detail below with respect to FIGS. 3 and 4.

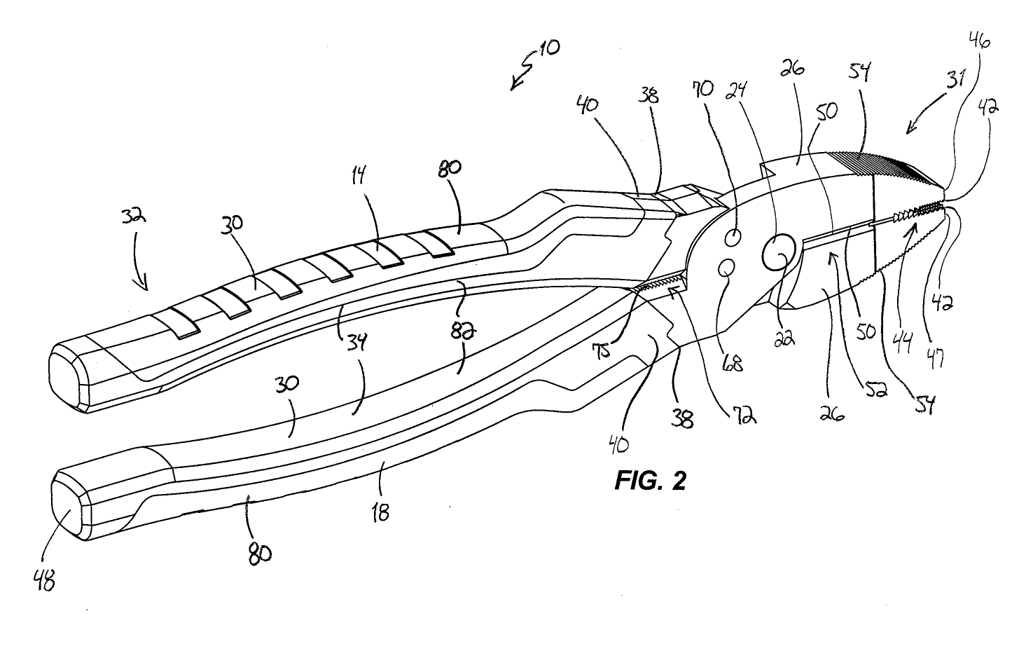

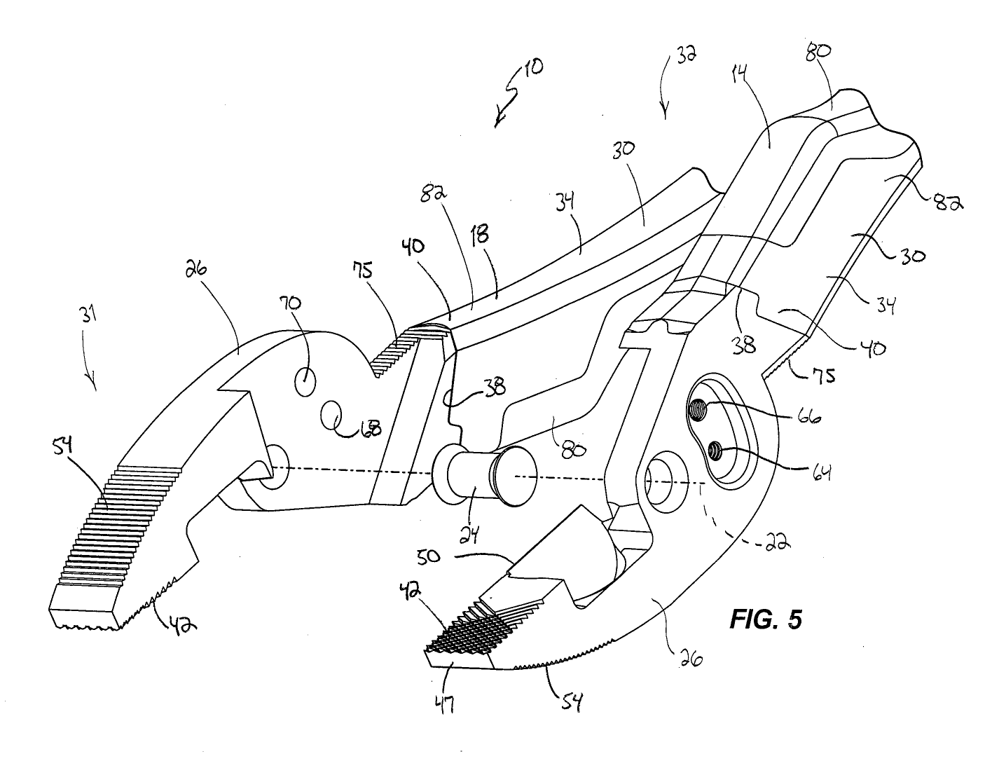

Referring to FIGS. 1 and 5, each of the head portions 26 includes ribs or ridges 42 that create a first grip 44 at a nose 46 of the pliers 10. The nose 46 defines a first end 47 of the pliers 10 whereas the handle portions 30 define a second end 48 of the pliers 10 opposite the first end 47. The nose 46 generally tapers toward the first end 47 from the second end 48. Behind the grip 44 (between the grip 44 and the pivot point 22) the members 14, 18 both include a sharp edge 50 (FIG. 2). Together the sharp edges 50 define a cutter 52 of the pliers 10. The pliers 10 is opened and closed by pivoting the members 14, 18 about pivot point 22 and the cutter 52 can be used to cut wire, wire insulation (i.e., a wire stripper), or other suitable material.

With continued reference to FIG. 1, the pliers 10 further includes a plurality of ridges 54 that extend parallel to each other along the head portion 26 of the first member 14 and generally face a first direction. Ridges 54 also extend parallel to each other along the head portion 26 of the second member 18 and generally face a second direction that is directly opposed to the first direction. The ridges 54 and edge allow the user to use the pliers 10 to ream a pipe to remove burrs or otherwise smooth the inside of a pipe wall along a cut of the pipe. To use the pliers 10 as a reamer, the user inserts the nose 46 of the pliers 10 into a pipe or the like, until the pipe wall contacts the ridges 54 and the user rotates the pipe or pliers 10 so that the ridges 54 remove burrs and smooth the pipe wall along the cut.

Referring to FIGS. 1 and 5, the pliers 10 further includes a first threaded aperture 64 and a second threaded aperture 66 that are used as a threaded fastener cutter. The apertures 64, 66 extend through the head portion 26 of the first member 14 between the pivot 22 and the second end 48 of the pliers 10. In the illustrated embodiment, the first aperture 64 has a first diameter and is sized to receive a #6 Unified National size bolt and the second aperture 66 has a second diameter, larger than the first diameter, and sized to receive a #8 Unified National size bolt. In other embodiments, the apertures 64, 66 can have any suitable size. In operation, the user opens the handle 32 and the head 31 and then threads a fastener into one of the apertures 64 or 66 and then closes the handle 32 to close the head 31, which cuts the fastener. In an alternative operation, the second member 18 includes a first unthreaded aperture 68 and a second unthreaded aperture 70. The first unthreaded aperture 68 is aligned with the first threaded aperture 64 to receive the threaded fastener when the handle 32 is closed (position illustrated in FIG. 1) and the second unthreaded aperture 70 is aligned with the second threaded aperture 66 to receive the threaded fastener when the handle 32 is closed. Therefore, the user can insert the threaded fastener into one of the threaded apertures 64 or 66 until the fastener enters the corresponding aperture 68 or 70. Then, the user can open the handle 32 or separate handle portions 30 about the pivot 22 to shear and cut the fastener. The threads of apertures 64, 66 protect the threads of the fastener from damage during cutting.

Referring to FIGS. 2 and 3, the pliers 10 further includes a second grip 72 located behind the threaded apertures 64 and 66 and between the aperture 64 and 66 and the second end 48 of the pliers 10. Ridges 75 are formed on the head portions 36 of both of the members 14, 18 to form the second grip 72. The second grip 72 provides the user with an additional area to grip material, crimp wire, and the like.

Accordingly, the pliers 10 includes several accessory features, such as a wire strippers, a wire cutter, a pipe reamer, a threaded fastener cutter, and a first grip and a second grip. This particular arrangement of accessory features on the pliers 10 has been found particularly convenient and advantageous for use as a lineman's pliers.

Referring to FIG. 4, the pliers 10 is formed from a frame 74 and the handle over molds 34 (FIG. 3) are molded directly onto the frame 74. As discussed above, the illustrated frame 74 is formed from metal by casting, and/or forging machining and a coating may be chemically bonded to the finished surfaces. The chemically bonded coating provides an attractive gray or black finish to the pliers 10 and protects the pliers 10 from corrosion. As illustrated in FIG. 4, the frame 74 is formed with apertures 76 that extend laterally through the handle portions 30 of the members 14, 18. Also, the frame 74 is formed with a recess 78 that extends circumferentially around both the handle portions 30 adjacent the second end 48 of the pliers 10. Although the illustrated embodiment includes both the apertures 76 and the recesses 78, in other embodiments, the frame 74 may include only either the apertures 76 or the recesses 78 or some combination thereof.

The over molds 34 include a first over mold 80 and a second over mold 82 (FIG. 3). The first and the second over molds 80 and 82 are molded directly onto the handles 30 by placing the frame 74 into a mold used to form the over molds 80, 82. Alternatively stated, the over molds 80, 82 are not formed separate or unattached from the frame 74 and then later slid onto or attached to the frame by using an adhesive or friction fit. During the molding process, the over molds 80, 82 extend through the apertures 76 and into the recesses 78 to fixably attached the over molds 80, 82 to the frame 74. The over molds 80, 82 are fixably attached such that the over molds 80, 82 generally cannot be removed without permanently damaging the over molds 80, 82 (e.g., cutting the over molds 80, 82). While the illustrated frame 74 includes the apertures 76 and recesses 78, in other embodiments, other features, such as a deep groove, ribs or other non-smooth features, could be used to interlock the over molds 80, 82 to the frame 74.

As discussed above, traditionally, pliers have had their handles dipped in a bath of rubber and not directly molded to the frame as previously discussed. With this traditional dipping process, the rubber can easily rip, tear, crack or slide off of the frame. In other traditional processes, the grips are premolded separate from the tool and then glued and pressed onto the frame using an adhesive. With this traditional process, the glue can breakdown, especially if the tool becomes hot, and the grips pull off of the tool.

Accordingly, the present invention provides a pliers that includes an improved handle structure that is especially resistant to damage and an arrangement of features that has been found to be particularly useful in a lineman's pliers. Various features are set forth in the following claims.

What is claimed is:

1. A pliers comprising:
a first member including a head portion and a handle portion;
a second member pivotally coupled to the first member, the second member including a head portion and a handle portion, the head portions of the first and the second members defining a head of the pliers and the handle portions of the first and the second members defining a handle of the pliers;
a first end defining a nose of the head portion;
a second end, opposite the first end, defined by the handle of the pliers;
a first plurality of ridges disposed on the first member adjacent the nose;
a second plurality of ridges disposed on the second member adjacent the nose, the first and the second plurality of ridges together defining a grip of the pliers;
a first sharp edge disposed on the first member adjacent the first plurality of ridges and between the first plurality of ridges and the second end of the pliers;
a second sharp edge disposed on the second member adjacent the second plurality of ridges and between the second plurality of ridges and the second end of the pliers, together the first and the second sharp edges defining a cutter of the pliers;
a pivot that pivotally couples the first member and the second member adjacent the cutter and between the cutter and the second end of the pliers; and
an aperture that extends through the first member adjacent the pivot and between the pivot and the second end of the pliers, the aperture and the second member defining a fastener cutter of the pliers.

2. The pliers of claim 1, further comprising,
a third plurality of ridges disposed on the first member between the fastener cutter and the second end; and
a fourth plurality of ridges disposed on the second member between the fastener cutter and the second end,
wherein the grip is a first grip, and
wherein the third and fourth plurality of ridges define a second grip of the pliers.

3. The pliers of claim 1,
wherein the first plurality of ridges generally face a first direction,
wherein the second plurality of ridges generally face a second direction generally directly opposed to the first direction, the pliers further comprising,
a third plurality of ridges disposed on the head portion of the first member and generally facing the second direction; and
a fourth plurality of ridges disposed on the head portion of the second member and generally facing the first direction,
wherein the third and fourth plurality of ridges are configured to define a pipe reamer of the pliers.

4. The pliers of claim 1,
wherein the aperture is a first aperture having a first diameter and the fastener cutter is a first fastener cutter, the pliers further comprising,
a second aperture that extends through the first member adjacent the pivot and between the pivot and the second end of the pliers, the second aperture having a second diameter larger than the first diameter and the second aperture and the second member defining a second fastener cutter of the pliers.

5. The pliers of claim 1, wherein the handle portion of the first member includes a resilient grip member that abuts the head portion of the first member such that the resilient grip member includes an outer surface that is flush with the head portion of the first member to define a smooth transition between the resilient grip member and the head portion of the first member.

6. The pliers of claim 5,
wherein the handle portion of the first member includes a recess, and
wherein the first resilient grip member extends into the recess to fixably couple the first resilient grip member to the first member without adhesive.

7. The pliers of claim 6, wherein the recess of the first member extends circumferentially around the handle portion of the first member.

8. The pliers of claim 6, wherein the recess of the first member extends laterally through the handle portion of the first member.

9. A pliers comprising:
a first member including a head portion and a handle portion;
a second member pivotally coupled to the first member, the second member including a head portion and a handle portion, the head portions of the first and the second members defining a head of the pliers and the handle portions of the first and the second members defining a handle of the pliers;
a first resilient grip member located on the handle portion of the first member, the first resilient grip member abuts the head portion of the first member such that an outer surface of the first resilient grip member is flush with the head portion of the first member to define a smooth transition between the first resilient grip member and the head portion of the first member; and
a second resilient grip member located on the handle portion of the second member, the second resilient grip member abuts the head portion of the second member such that an outer surface of the second resilient grip member is flush with the head portion of the second member to define a smooth transition between the second resilient grip member and the head portion of the second member.

10. The pliers of claim 9,
wherein the handle portion of the first member includes a recess, and
wherein the first resilient grip member extends into the recess to fixably couple the first resilient grip member to the first member,
wherein the handle portion of the second member includes a recess, and
wherein the second resilient grip member extends into the recess of the second member to fixably couple the second resilient grip member to the second member.

11. The pliers of claim 10, wherein the recess of the first member extends circumferentially around the handle portion of the first member.

12. The pliers of claim 10, wherein the recess of the first member extends laterally through the handle portion of the first member.

13. The pliers of claim 9, further comprising:
a first end defining a nose of the head portion;
a second end, opposite the first end, defined by the handle portion of the pliers;
a first plurality of ridges disposed on the first member adjacent the nose;
a second plurality of ridges disposed on the second member adjacent the nose, the first and second plurality of ridges together defining a grip of the pliers;
a first sharp edge disposed on the first member adjacent the first plurality of ridges and between the nose and the second end of the pliers;
a second sharp edge disposed on the second member adjacent the second plurality of ridges and between the nose and the second end of the pliers, together the first and second sharp edges defining a cutter of the pliers;
a pivot that pivotally couples the first member and the second member adjacent the cutter and between the cutter and the second end of the pliers; and
an aperture that extends through the first member adjacent the pivot and between the pivot and the second end of the pliers, the aperture and the second member defining a fastener cutter of the pliers.

14. The pliers of claim 13, further comprising,
a third plurality of ridges disposed on the first member between the fastener cutter and the second end; and
a fourth plurality of ridges disposed on the second member between the fastener cutter and the second end,
wherein the grip is a first grip, and
wherein the third and the fourth plurality of ridges define a second grip of the pliers.

15. The pliers of claim 13, further comprising,
wherein the first plurality of ridges generally face a first direction,
wherein the second plurality of ridges generally face a second direction generally directly opposed to the first direction, the pliers further comprising,
a third plurality of ridges disposed on the head portion of the first member and generally facing the second direction; and
a fourth plurality of ridges disposed on the head portion of the second member and generally facing the first direction,
wherein the third and fourth plurality of ridges are configured to define a pipe reamer of the pliers.

16. The pliers of claim 13,
wherein the aperture is a first aperture having a first diameter and the fastener cutter is a first fastener cutter, the pliers further comprising,
a second aperture that extends through the first member adjacent the pivot and between the pivot and the second end of the pliers, the second aperture having a second diameter larger than the first diameter and the second aperture and the second member defining a second fastener cutter of the pliers.

17. A method of manufacturing a pliers comprising:
providing a frame that defines a head and a handle of the pliers;
molding a resilient grip member directly onto the handle of the pliers,
wherein molding the resilient grip member directly onto the handle includes extending a portion of the resilient grip member into a recess of the handle to fixably couple the resilient grip member to the handle.

18. The method of claim 17, wherein extending a portion of the resilient grip member into the recess includes extending a portion of the resilient grip member through a recess that extends laterally through the handle of the pliers.

19. The method of claim 17, wherein molding the resilient grip member onto the handle includes abutting the resilient grip member to the head of the pliers such than an outer surface of the resilient grip member is flush with the head to define a smooth transition between the grip member and the head.

20. The method of claim 17, wherein molding the resilient grip member directly onto the handle does not include the use of an adhesive.
